(19) United States
(12) Patent Application Publication
(10) Pub. No.: US 2013/0227142 A1
(43) Pub. Date: Aug. 29, 2013

(54) PROVISION RECOGNITION LIBRARY PROXY AND BRANDING SERVICE

(71) Applicants: Jeremy A. Frumkin, Tucson, AZ (US); Terry Reese, Independence, OR (US)

(72) Inventors: Jeremy A. Frumkin, Tucson, AZ (US); Terry Reese, Independence, OR (US)

(21) Appl. No.: 13/404,701

(22) Filed: Feb. 24, 2012

(51) Int. Cl. G06F 15/173

(52) U.S. Cl. 709/226

(57) ABSTRACT

Systems and methods for enabling organizations such as libraries, as brokers of digital information, the ability to automatically and uniquely modify (e.g., brand) the resources they broker at the time those resources are delivered to users. This is accomplished through an improved architectural approach for information flow through a library that enables a library to act upon a digital information resource by ensuring that it is routed through the library on its path back to the end user. The embodiments also include a branding service that enables libraries to automatically and uniquely brand information resources that are delivered through this architectural approach.

### FIELD OF THE INVENTION

The present invention relates generally to systems and methods for provisioning information resources, and more particularly, to systems and methods for enabling libraries to automatically and uniquely modify digital information resources during flow from content providers to users.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

As with other entities, libraries need to market the value they provide to their users and user communities. Historically, use of the library has been a knowing activity—a user would physically go into a library building, discover information through the library's card catalog or by working with a librarian, and then retrieve a physical item from the library's shelves. Even as libraries began adopting Internet technologies, their presence within a research workflow remained relatively visible.

With the emergence of Internet search engines and related tools, the library's role began to evolve. Instead of being the sole point of discovery for information, libraries now are in an environment where discovery often happens elsewhere (i.e., outside of the library). In fact, many of the resources users previously would only find in a library are now easily discovered on the Internet.

However, this does not mean that these resources, now more readily discoverable, are freely available. The library's role in provisioning access to resources, both freely and not freely available, is increasingly important. This fact presents libraries with a new challenge: how to garner recognition for their role as information broker.

Current library technology architectures often utilize a proxy server to allow a library to broker accessed or provisioned content (or simply “content” or a “resource”) to the library's users. By far the most common proxy server technology currently deployed by libraries is EZProxy available from Online Computer Library Center, Inc., Dublin, Ohio. Regardless of the proxy server technology used, a typical library infrastructure deploying a proxy provides a one-way mechanism for authenticating and authorizing access to resources. This is illustrated by the process 100 shown in FIG. 1. A user makes an information retrieval request, which is received at a library proxy server, step 104. This request is sent through the library's proxy server, where the proxy server validates the identity of the user, step 108, and then sends the request on to the actual information content provider, step 112. Once the request is handed off to the content provider, the content provider fulfills the request and sends the requested information resource directly back to the user, steps 116 and 120.

Within this conventional workflow, the proxy server component serve's two primary roles: identity management and content mediator. Typically, library proxy servers interact with an organization's identify management system (e.g., Shibboleth, Lightweight Directory Access Protocol (LDAP), etc.) to validate the identity of a user or to provide information regarding a user's memberships or affiliation with a specific organization to provide conditional access to published content.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 depicts a flow chart of a prior art process for the flow of information resources from a content provider to a user in a library's information technology system.

FIG. 2 depicts a block diagram illustrating an exemplary architecture for a provision recognition system according to an embodiment of the present invention.

FIG. 3 depicts a flow chart of an exemplary process for implementing the provision recognition system shown in FIG. 2.

FIG. 4 depicts a flow chart of an exemplary process for an extended service server interacting with a proxy server to act on an information resource.

FIG. 5 depicts a flow chart of an exemplary process for provisioning a resource using an extended service.

FIG. 6 depicts a flow chart of an exemplary process for a branding service of the provision recognition system.

FIG. 7 depicts a diagram of a hardware environment and an operating environment in which one or more computing devices associated with the provision recognition system of the present invention may be implemented.

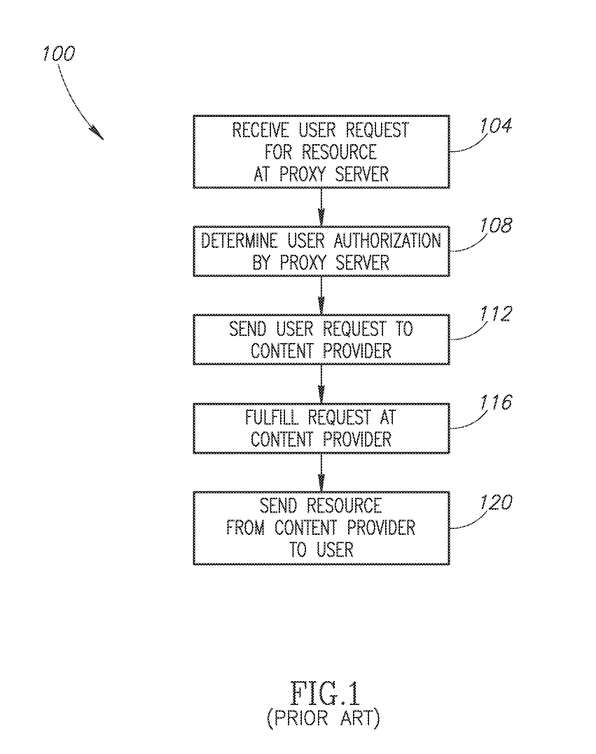

### DESCRIPTION OF THE INVENTION

One skilled in the art will recognize many methods, systems, and materials similar or equivalent to those described herein, which could be used in the practice of the present invention. Indeed, the present invention is in no way limited to the methods, systems, and materials described.

Embodiments of the present invention relate to systems and methods for enabling libraries, as brokers of digital information, the ability to automatically and uniquely modify (e.g., brand) the resources they broker at the time those resources are delivered. The embodiments described below enable this ability through an improved architectural approach for information flow through a library's technology system (or more generally, an organization's technology system) that enables a library to act upon a digital information resource by ensuring that it is routed through the library's system on its path to the end user.

With electronic databases, electronic journals, and electronic books, libraries will have the opportunity to utilize the embodiments of the present invention to brand the information resources they deliver to users.

Branding electronic delivery of information resources presents a number of challenges. One such challenge is that conventional branding techniques lack “stickiness,” meaning that identification of the source or provider of the resource does not necessarily stay attached to the resource itself. Visibility is limited to branding methods within the content provider's delivery systems. However, these methods are often ineffectual as many search services no longer send users into a content provider's delivery systems, but rather send users directly to their information resource. Since current branding techniques lack “stickiness,” users are given only minimal clues as to how the information was provisioned on their behalf. At a time when libraries are being asked to defend their budgets, visibility of the library's value within the information resource delivery chain is critical.

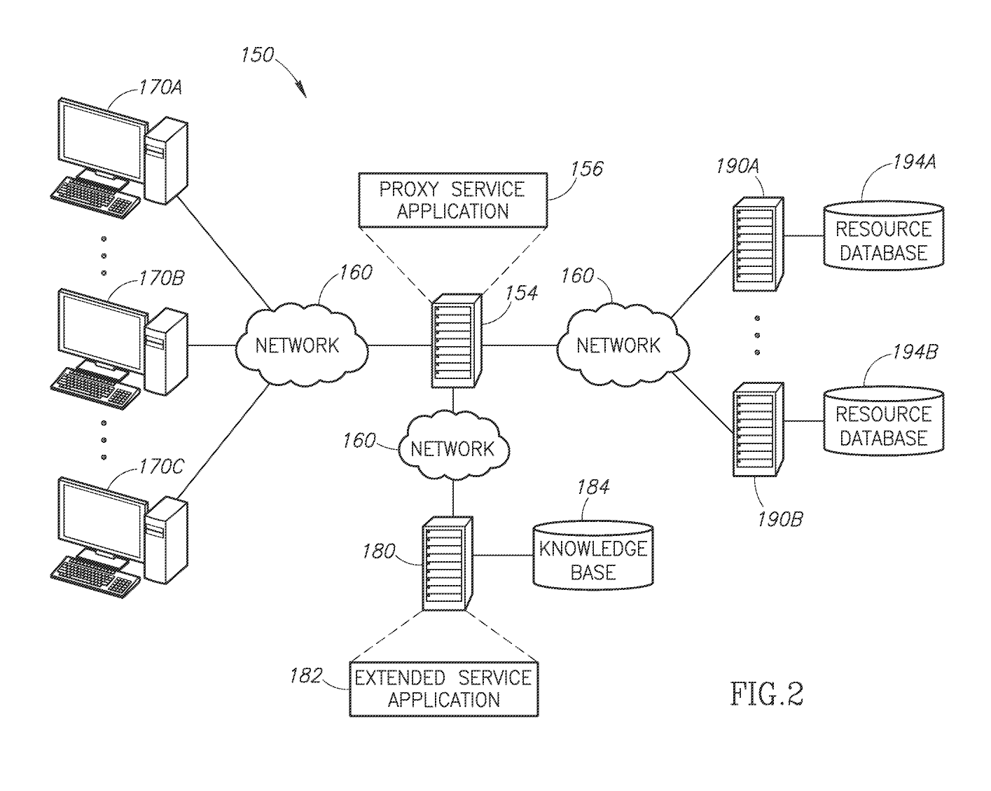

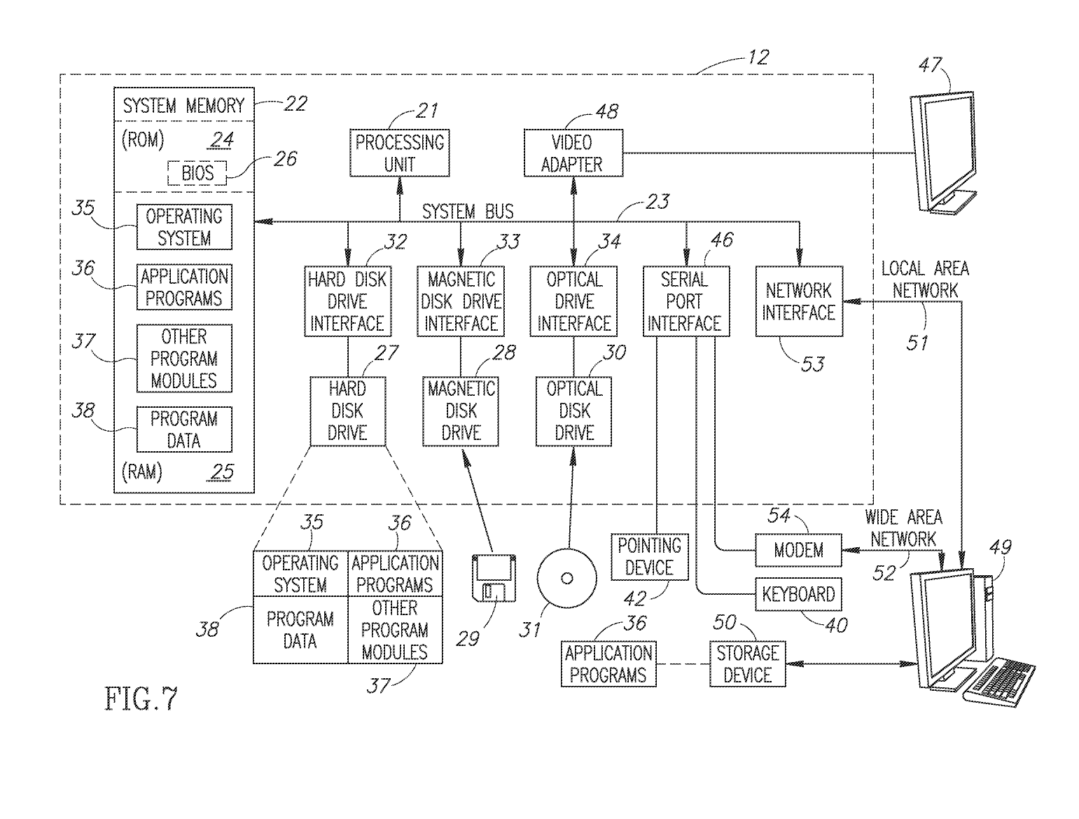

FIG. 2 depicts a block diagram of a provision recognition system 150 (or “system”) for library technology systems according to an embodiment of the present invention. A diagram of an example hardware environment and an operating environment in which the system 150 may be implemented is shown in FIG. 7 and is described below.

The system 150 comprises a library proxy server 154 executing a proxy service application 156 that is communicatively coupled to a plurality of client or user computers 170A-C over a network 160, such as the Internet, local area network (LAN), or other type of network. The proxy server 154 is also communicatively coupled over the network 160 to a plurality of content provider database servers 190A-B that are operative to retrieve resources from resource databases 194A-B. The proxy server 154 is also coupled via the network 160 to an extended service web server 180 executing an extended service application 182, which is configured to access a knowledge base 184. It should be appreciated that the terms “server” and “service” are to be construed in this disclosure as being synonymous and can be used interchangeably, and may refer the hardware, software, and/or data necessary for carrying out the described functionality. The operation of the system 150 is described in detail below.

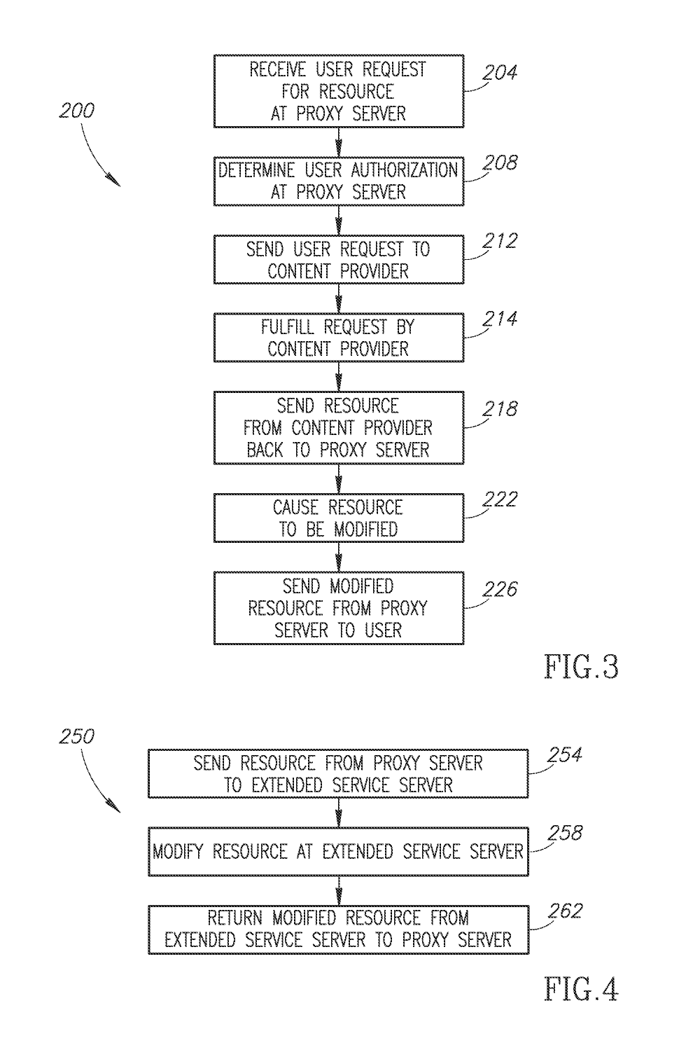

FIG. 3 illustrates a workflow process 200 for implementing the system 150. A user first makes an information retrieval request, which is received at the library's proxy server 154, step 204. This request is sent through the proxy server 154, where the proxy server validates the identity of the user, step 208, and then sends the request on to the information content provider (e.g., the content provider databases 190A-B shown in FIG. 2), step 212. Once the request is handed off to the content provider, the content provider fulfills the request and sends the requested information resource back to the proxy server 154, steps 211 and 216, rather than directly back to the user. Next, the proxy server 154 causes (directly or indirectly) the resource to be modified, step 222, and sends the modified resource to the user, step 226.

While the proxy service workflow 200 is transparent to the user, it represents a service point through which a library's electronic resources flow. As FIG. 3 demonstrates, the functionality of the proxy server 154 is extended to allow it to directly act upon a specific resource or call a service or process of the extended service web server 180 to act upon a resource on the proxy server's behalf. Thus, a new set of services is available to provide value added information to the retrieved content on behalf of the user.

FIG. 4 is a flow chart of a process 250 that details the interaction of the extended service application 184 of the extended service web server 180 with the proxy server 154. The process 250 may begin after the proxy server 154 receives the requested resource from one of the content providers 190A-B. The proxy server 154 may send the retrieved resource to the extended service web server 180, step 254. The extended service web server 180 may then act upon the resource to modify the resource, step 258. Once the extended service web server 180 has completed its task, it may then return the modified resource back to the proxy server 154 so that the modified resource may be provided to the end user.

Generally, the process 250 demonstrates how the provision recognition system 150 of the present invention may be injected into a traditional proxy service environment as an extended service application 184. By augmenting the proxy service workflow, the provisioning system 150 is able to act upon the resource after the user has already been validated and the resource has been retrieved from the content providers 190A-B making content negotiation between the extended service web server 180 and the content providers 190A-B unnecessary.

Moreover, the provisioning system 150 may utilize information from the library system's identity management system to customize messages to users based on the users' identification or affiliation. This information may be stored in the knowledge base 184 and may be accessible by services executing on either the proxy server 154 or the extended service web server 180.

By transforming the “actual information resource,” the modification information (e.g., branding information) stays, or “sticks,” with the resource. By enabling the modification to remain with the information resource, the modification becomes, in particular embodiments, a permanent feature, an optionally permanent feature, or a reversibly permanent feature, a linked feature, or a deconstructable or uncoupleable feature of the information resource, as opposed to a transient feature. As information technology moves toward a post-PC era, where content needs to be mobile across different types of devices, incorporating the modifications into the information resource itself allows them to persist across devices (phones, tablets, netbooks, etc.) and research support tools (Endnote®, Zotero®, Mendeley®, etc.).

As discussed above, libraries traditionally provision access to information to their users through a proxy server, such as the proxy server 154 shown in

FIG. 2. The proxy server 154 allows libraries to act as a mediator on behalf of the user, establishing a secure relationship between the user and the content provider or providers 190A-B. In embodiments of the present invention, the traditional role of the proxy server 154 as an information mediator is extended to provide a single service point that allows other library services the ability to connect to, and act upon, information being provisioned to the user. In this model, the proxy server 154 is extensible—it enables the ability for other services, such as services provided by the extended service web server 180 to connect to the proxy server (and vice-versa), such as the branding service application described below.

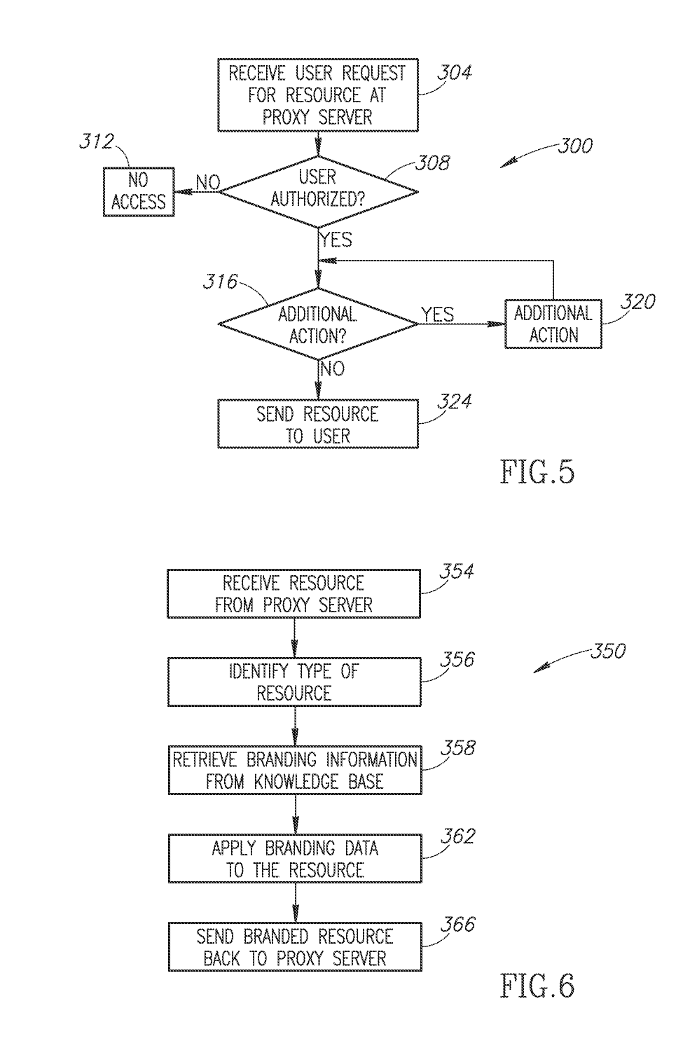

FIGS. 5 and 6 depict processes 300 and 350, respectively, which illustrate an example of a way in which the inventive system 150 may modify the existing content provisioning process of a library's technology system. As shown in FIG. 5, the proxy server 154 (or proxy service application 156) is disrupted, as it is no longer a passive actor but is instead an active participant in the information provisioning workflow. By utilizing an active and extensible proxy service application 156, libraries have the ability to inject new functionality into the proxy server process, thereby enabling new types of features and actions to take place during the process of delivering information to users. In this model, the proxy service application 156 continues to provide access control to the resources, but that is not the sole function of the proxy service. Instead, the active and extensible proxy service application 156 is able to evaluate user requests against the various new actions available to it, directing the user requests and information flow appropriately.

The process 300 begins when a user initiates a request for a resource and the request is passed through the proxy server 154, step 304. The proxy server 154 evaluates the credentials provided by the user to determine their access rights to the resource, step 308. If the credentials are insufficient (step 308 equals “no”), access to the resource is denied. If the user's credentials are sufficient (step 308 equals “yes”), the proxy server 154 determines if any additional actions or “plug ins” should be performed based on available extended services, step 316. Since actions are event oriented, these additional actions may be ones that occur directly after authentication (step 308), after retrieving the information resource (e.g., after step 218 of the process 200 shown in FIG. 3), or as the resource is streamed over the network 160 to the user. If additional actions are to be performed, the proxy server 154 processes the additional act by, for example, calling the extended service application 182, step 320. Once the extended service application 182 has executed, the proxy server 154 may then return the resource to the user, step 324.

FIG. 6 illustrates the operation of an exemplary extended service application 182, namely, a branding service, that may be implemented within the workflow shown in FIG. 5 as an extended service interacting with the information resource through routing from the proxy server 154. While the branding service itself may be a separate set of services existing outside of the proxy server 154, it may be called and initialized by the proxy server 154 level. Specifically, the branding service may be called at the event level after the information resource has been retrieved by the proxy server 154, but prior to the object being sent back to the user. For example, the branding service may be called during step 222 of the process 200 shown in FIG. 3. In other embodiments, the branding service may be implemented as part of the proxy service application 156, rather than as an extended web service.

Within the information workflow described above with reference to FIG. 5, the branding service executes when the proxy service determines that an additional action should be performed (i.e., step 316 in FIG. 5 equals “yes”). The branding service receives the information resource from the proxy server 154, step 354. The branding service may then pass the information resource through a resource type identification filter to identify the type of information resource, step 356, and may also retrieve branding information from the knowledge base 184, step 358. Next, the branding service passes the information resource through a processing filter to apply the branding data to the information resource, step 362. As an example, the branding data may include textual and/or graphical data that provides identification of an entity, such as the library providing the resource to the user. Once the information resource has been branded, the branding service may send the branded resource back to the proxy server 154, step 366. The proxy server 154 may then determine if an additional actions need to be performed on the resource, and call or perform those additional actions if needed. Once no other actions need to be performed on the resource, the proxy server 154 may send the resource to the user (step 324 of FIG. 5).

In some embodiments, a user may want to decouple or otherwise remove the branding information from a provisioned resource. The system described herein may utilize a variety of methods to provide this feature to a user. For example, the system may provide a user with, in addition to the branding information, a link to a non-branded version of the resource, allowing the user to download the non-branded version by clicking on that link. This link may be provided to the user in a separate document (e.g., PDF, email, etc.) or may be directly coupled or branded to the branded resource itself. In other embodiments, a user may be allowed to select an option to download the branding information with the original resource, but packaged as a separate file. In other embodiments, users and/or other entities may be able to select the branding information to be applied to the resource, including all, a portion, or none of the available branding information. Methods and options that allow for the decoupling or removal of branded information are provided by the systems disclosed herein. These features illustrate the potential to embed a variety of services, options, and features into the methods described herein.

Various components such as Apache Foundation's web server components may be utilized to build and deploy the proxy services described herein. The Apache™ web server may be utilized to provide an extensible platform for providing configurable proxy services, while at the same time, leveraging the ability to build new services and functions as part of the proxy process.

The embodiments of the present invention also provide the opportunity for libraries to better understand the actual use of the resources they provision to users. For example, data relating to which resources are being used and from which information providers resources are being delivered may be captured by the system 150. Moreover, depending on the information passed to the extensible proxy server 154, information may also be captured regarding types of users and what types of resources they are using.

For example, if an institution passes on role information, such as whether a user is a faculty member, graduate student, undergraduate, etc., that information may be captured in relation to the resources that were brokered for the user. That information may then be aggregated with similar information. This aggregated set of data may be utilized by a library to support decision-making in regards to its information licensing and information purchasing. The data may also be disseminated through reports to external stakeholders to demonstrate a library's value to selected subsets of its user community, such as a college or department, or a class of users, such as faculty or students. More broadly, deploying this particular approach in a cloud environment may enable an aggregation of data across institutions, allowing library consortia, or even the greater library community, to better understand the use and trends related to provisioned information resources.

The branding service is now described in further detail as one example of the extended service application 182 shown in FIG. 2. As a web service, the branding service may stand alone and may be inserted into multiple workflow scenarios. While this disclosure describes the proxy service layer as one location for its execution, it should be appreciated that the branding service may be inserted within any part of the information provision workflow. For example, the branding service may be tied to a library's discovery system or their OpenURL resolver.

In some embodiments, the branding web service may function by receiving a uniform resource identifier (URI) to a remotely accessible information resource. As an example, the branding service may provide support for a variety of resource file formats, including but not limited to portable document format (PDF), electronic book (e-book), and HTML encoded documents. Utilizing the provided URI, the branding service may retrieve the specified content, evaluate its format, and apply the specified branding information as specified by the owner or provisioning entity of the resource. Generally, branding information may include many different types of data including textual and graphical data (e.g., images, etc.), and as such, the branding service supports multi-faceted branding options.

As discussed above with reference to FIG. 6, the technology involved in implementing the branding service is multi-fold. The branding service utilizes resource type identifier filters to recognize the resource type being passed into the branding service and to select and initialize a processing filter. The processing filters include libraries of code that enable the modification of the resource. These filters enable the branding data to be embedded within the resource file itself. The branding service also utilizes the knowledge base 184, which contains user preferences and functions in tandem with the branding service to configure the options and branding content to be added to a resource. Further, the branding service may exist as a system-independent web service to provide optimum flexibility for users looking to implement the branding service. Each of these aspects of the branding web service is described in further detail below.

The resource type identifier filters allow the branding service to auto-identify the type of resource or object to be processed. Utilizing Multipurpose Internet Mail Extensions (MIME) types and heuristic object analysis, the resource type identifier filters provide the primary methodology for routing information resources or objects passed into the branding service to the correct processing filter.

Processing filters encapsulate the necessary logic needed to perform a requested action on an information resource. In this case, the processing filters perform the actual disassembling, branding, and re-assimilation of the information resource. Since each resource type format requires different methodologies for disassembling, branding, and re-assembling the modified resource, the branding service includes processing logic for each supported resource type (e.g., PDF, ebook, etc.). For those resource types without a processing filter, the branding service may provide an escape filter to enable information resources to pass cleanly back out of the branding service and back to the proxy server 154 or to the user.

The knowledge base 184 represents an ancillary component of the branding service and is operative to maintain business information about the service's users and their desired level of interaction with the branding service. The knowledge base 184 allows organizations utilizing the branding service to set preferences, logos, images and logging levels, and then to reference or modify these preferences through a unique user identification system.

For users of the branding service, the knowledge base 184 also represents a visible aspect of the system 150, due to the customized nature of the service. While the processing and filtering components of the branding service do the “heavy lifting,” providing the technical capacity for enhancing information resources served through the service, the knowledge base 184 provides the context and organizational proprietary information from which the branding service draws.

For example, organizations utilizing the branding service may wish to provide “digital bookplates” to acknowledge donors or funding sources providing access to content, making the knowledge base 184 a potentially useful tool for extending donor relations. As another example, an organization may wish to include information analysis related to the cost of the information object, to tangibly demonstrate to users the cost of information access being born by the organization. These types of options, in addition to the ability to provide custom messaging, logos, and branding types provide organizations a spectrum of options to demonstrate their ongoing value to their user communities.

As discussed above, in order to provide support for many different provisioning workflows, the branding service may be developed outside of the proxy service application 156 as a separate web services component. By separating the two services and providing the branding service as its own individual service level component, the implementation of the system 150 may be significantly more flexible and nuanced to suit each individual user community.

In developing a web services framework, the branding service may provide its functionality through a service level Application Programming Interface (API). As an example, the API in the form of a Representational state transfer (REST) based and/or JavaScript Object Notation (JSON) based API structures since these are currently two ubiquitous forms of API usage in web driven development. Of course, as technology changes, these APIs may be enhanced and expanded to support various new technologies.

Presently, the branding service implements two service level API functions. A first API function takes the following arguments:

(1) uri: URI to the proxied URL to be processed;

(2) logo—URI path to a logo or image to be placed on the branded document; and

(3) text—Branded message.

At its most basic level, the first API function provides a simplified method to interact with the branding service outside of the knowledge base 184. In this case, information related to logos, URIs, and branding preferences are fed into the branding service via the API. In this scenario, the calling application or process is responsible for providing all information to the branding service. That is, the outside process initiates a request with the branding service, and provides the resource URI and branding preferences to the API. The API communicates with the branding service, validates the URI, and identifies the resource type and selects a processing filter using the resource type identification filter discussed above. The selected processing filter of the branding service then disassembles, brands, and reassembles the resource, and returns the branded resource via the API to the user.

The simplified first API function or signature potentially offers a wide variety of conditional uses for the branding service, while at the same time requiring implementers to take full responsibility for providing the necessary branding preferences to the branding service each time it is initialized.

To simplify the process of utilizing the branding service, a second API function is provided that connects directly to the branding service knowledge base 184. The arguments for the second API function include:

(1) uri: URI to the proxied URL to be processed; and

(2) id: Stored customer ID.

In this workflow, organizations utilizing the branding service may configure their branding preferences once within the branding service knowledge base 184. Once configured, organizations may initialize the branding service simply by providing a URI for processing and a customer ID. In this regard, the branding service is operative to determine identify of the organization and/or user requesting the information resource, and to consult the knowledge base 184 to extract preselected branding preferences. Then, the branding service may filter and process the resource as discussed above using the branding preferences retrieved from the knowledge base 184.

Within this workflow, the second API function is more closely tied to the branding service itself, as users of the branding service are known entities. The benefits of this approach lie in the ability to customize services specifically for known users, and in the ability to provide users the option to provide additional details about their content. The more rich content that the branding service has available within the knowledge base 184, the more available preferences are available to the user. Further, as users utilize the service and information is collected during the service's use, new and innovative ancillary services may be provided to further help to improve the provisioning of information at different levels within the information workflow.

It should be appreciated that although the branding service described herein is one example of an extended service that may be used by a library's proxy server, other services operative to modify information resources as they are passed from content providers to end users may also be utilized according to the embodiments of the present invention.

### Data Capture and Analysis

The architecture of the embodiments described above advantageously facilitates the capture and analysis of data that may be used for numerous purposes. As discussed above, data relating to the identity, associations, and roles of users, which resources are being used, and from which content providers the resources are being delivered may be captured by the system. This yields a vast set of valuable data that may be analyzed and used by interested entities, such as funding decision makers, politicians, and the like, to make decisions relating to the funding or services provided by an organization's digital resources provisioning system. As discussed above, the data may be analyzed to generate various reports that demonstrate the organization's value to these or other interested entities.

In addition to branding services, the architecture provides a collection point for the aggregation of data. By coupling the branding service to the proxy architecture, information about the user and their organizational status may be gleaned through as the user is authenticated through the proxy layer. These data points provide a number of unique opportunities to perform varied forms of collection analysis. Utilizing information about an authorized user, the system may generate reports detailing departmental usage (e.g., based on user membership), resource usage by user status (e.g., undergraduate, graduate or faculty), demonstrate the approximate cost per article usage based on current subscription rates, and the like. These statistics offer administrators a granular view of their organizational usage. Utilizing available metadata about a resource, additional usage information based on subject area or research domain may also be made available.

In addition to organizational analysis, the web service nature of the system provides opportunities for evaluating aggregate information. Information collected by an individual organization may be anonymized and shared in aggregate form to provide detailed usage pattern analysis of resources by, for example, organizational type (e.g., public or private university, academic or public library, college conference usage patterns). These usage patterns may be utilized to identify regional and organizational usage. Likewise, these aggregated patterns may be utilized to identify common resources, form likeminded cooperatives, and provide additional leverage in licensing discussions.

### Computing System

FIG. 7 is a diagram of hardware and an operating environment in conjunction with which implementations of the provision recognition system 150 may be practiced. The description of FIG. 7 is intended to provide a brief, general description of suitable computer hardware and a suitable computing environment in which implementations may be practiced. Although not required, implementations are described in the general context of computer-executable instructions, such as program modules, being executed by a computer, such as a personal computer or the like. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, cloud computing architectures, and the like. Implementations may also be practiced in distributed computing environments where tasks are performed by remote processing devices that are linked through one or more communications networks. In a distributed computing environment, program modules may be located in both local and remote memory storage devices.

The exemplary hardware and operating environment of FIG. 7 includes a general-purpose computing device in the form of a computing device 12. The computing device 12 includes the system memory 22, a processing unit 21, and a system bus 23 that operatively couples various system components, including the system memory 22, to the processing unit 21. There may be only one or there may be more than one processing unit 21, such that the processor of computing device 12 comprises a single central-processing unit (CPU), or a plurality of processing units, commonly referred to as a parallel processing environment. The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and may include read only memory (ROM) 24 and random access memory (RAM) 25. A basic input/output system (BIOS) 26, containing the basic routines that help to transfer information between elements within the computing device 12, such as during start-up, may be stored in ROM 24. The computing device 12 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media. The computing device 12 may also include one or more other types of memory devices (e.g., flash memory storage devices, and the like).

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37 (e.g., one or more of the modules and applications described above), and program data 38. A user may enter commands and information into the computing device 12 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may be connected by other interfaces, such as a parallel port, game port, a universal serial bus (USB), or the like. A monitor 47 or other type of display device is also connected to the system bus 23 via an interface, such as a video adapter 48. In addition to the monitor, computers typically include other peripheral output devices (not shown), such as speakers and printers.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 9 include a local-area network (LAN) 51 and a wide-area network (WAN) 52. Such networking environments are commonplace in offices, enterprise-wide computer networks, intranets and the Internet.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

What is claimed is:

1. A computer-implemented method for brokering the delivery of a digital resource from an organization's technology system to a user, the method comprising:
receiving a user identification and a request for a resource at a proxy server of the organization from a user over a network;
evaluating the user identification by the proxy server to determine whether the user has access rights to the resource;
requesting by the proxy server the resource from a content provider system over the network when it is determined that the user has access rights to the requested resource;
receiving the resource at the proxy server from the content provider system over the network;
modifying by the proxy server the resource using modification information to create a modified resource; and
sending the modified resource to the user over the network.

2. The method of claim 1, wherein modifying the resource comprises:
sending by the proxy server the resource to an extended service over the network, wherein the extended service is operative to modify the resource using the modification information to create the modified resource; and
receiving the modified resource at the proxy server from the extended service over the network.

3. The method of claim 2, wherein the extended service is further operative to determine the type of the resource, and to modify the resource dependent on the determined type for the resource.

4. The method of claim 2, wherein the extended service is operative to retrieve the modification information from a knowledge base and the modification information is dependent upon the identity of at least one of the organization and the user.

5. The method of claim 1, wherein the modification information comprises branding information that includes textual data or graphical data.

6. The method of claim 5, wherein the textual data or graphical data provides an identification of the organization.

7. The method of claim 1, wherein the modification information comprises information relating to a cost of the digital resource had the user retrieved the digital resource from a source other than the organization.

8. The method of claim 1, wherein the digital resource is embodied in a portable document file (PDF) format, an electronic book (e-book) format, or an HTML format.

9. The method of claim 1, wherein the proxy server is operative to directly modify the resource according to the modification information.

10. The method of claim 1, wherein the modification information is dependent on the user identification provided by the user.

11. The method of claim 1, further comprising capturing data relating to the user identifications and requested resources for a plurality of users.

12. The method of claim 11, further comprising capturing role information data for a plurality of users that request a resource.

13. The method of claim 11, further comprising automatically generating a report using the captured data that identifies one or more characteristics of the operation of the method for brokering the delivery of a digital resource.

14. The method of claim 13, further comprising providing the report to an entity, wherein the entity utilizes the report to make one or more decisions concerning the organization.

15. The method of claim 1, further comprising sending a link to an unmodified version of the resource to the user over the network.

16. The method of claim 1, wherein the modification information applied to the resource is selectable by the user or the organization.

17. The method of claim 1, further comprising providing access to an unmodified version of the resource to the user over the network.

18. A computer-implemented method for modifying a digital resource during its delivery from an organization's technology system to a user, the method comprising:
receiving a digital resource from an organization's proxy server over a network;
modifying the digital resource using modification information to create a modified digital resource; and
sending the modified digital resource to the organization's proxy server over the network to be provided to a user.

19. The method of claim 18, further comprising determining the type of the digital resource, and modifying the digital resource dependent on its determined type.

20. The method of claim 19, further comprising retrieve the modification information from a knowledge base, wherein the modification information is dependent upon the identity of at least one of the organization and the user.

21. The method of claim 18, wherein the modification information comprises branding information that includes textual data or graphical data that provides an identification of the organization.

22. A system for brokering the delivery of a digital resource from an organization's technology system to a user, the system comprising:
an organization proxy server in operative communication with a client system and a content provider system, the proxy server being operative to:
receive a user identification and a request for a resource from a user operating the client system;
evaluate the user identification to determine whether the user has access rights to the resource;
request the resource from the content provider system when it is determined that the user has access rights to the requested resource;
receive the resource from the content provider system;
modify the resource using modification information to create a modified resource; and
send the modified resource to the client system of the user.

23. The system of claim 22, further comprising:
an extend service server in operative communication with the organization proxy server, wherein the organization proxy server is operative to modify the resource by:
sending the resource to the extended service server, which is operative to modify the resource using the modification information to create the modified resource; and
receiving the modified resource from the extended service server.

24. The system of claim 23, wherein the extended service server is further operative to determine the type of the resource, and to modify the resource dependent on the determined type for the resource.

25. The system of claim 22, further comprising a knowledge base operative to store the modification information, wherein the extended service server is operative to retrieve the modification information from the knowledge base, and the modification information is dependent upon the identity of at least one of the organization and the user.

26. The system of claim 22, wherein the modification information comprises branding information that includes at least one of textual data and graphical data that provides an identification of the organization.

27. The system of claim 22, wherein the proxy server is operative to directly modify the resource according to the modification information.

28. The system of claim 22, wherein the modification information is dependent on the user identification provided by the user.

29. The system of claim 22, further comprising capturing data relating to the user identifications and requested resources for a plurality of users.

30. A system for branding a digital resource during its delivery from an organization's technology system to a user, the system comprising:
a branding service operative to:
receive a digital resource from an organization's proxy server over a network;
determine the type of the digital resource;
retrieve branding information from at least one of the organization's proxy server and a knowledge base, the branding information including at least one of textual data and graphical data that provides an identification of the organization;
brand the digital resource using the branding information to create a branded digital resource; and
send the branded digital resource to the organization's proxy server over the network to be provided to a user.

31. A computer readable medium having stored thereon computer-executable instructions for performing a procedure to for brokering the delivery of a digital resource from an organization's technology system to a user, the procedure comprising:
receiving a user identification and a request for a resource at a proxy server of the organization from a user over a network;
evaluating the user identification by the proxy server to determine whether the user has access rights to the resource;
requesting by the proxy server the resource from a content provider system over the network when it is determined that the user has access rights to the requested resource;
receiving the resource at the proxy server from the content provider system over the network;
modifying by the proxy server the resource using modification information to create a modified resource; and
sending the modified resource to the user over the network.
